(19) United States
(12) Patent Application Publication
(10) Pub. No.: US 2016/0065613 A1
(43) Pub. Date: Mar. 3, 2016

(54) SYSTEM AND METHOD FOR DETECTING MALICIOUS CODE BASED ON WEB

(71) Applicant: SK INFOSEC CO., LTD., Seongnam (KR)

(72) Inventors: Rae Hyun Cho, Suwon (KR); Woo Jae Lee, Gwangju (KR); Seung Ho Ahn, Seoul (KR); Yong Kuk Kang, Seongnam (KR)

(73) Assignee: SK INFOSEC CO., LTD.

(21) Appl. No.: 14/843,395

(22) Filed: Sep. 2, 2015

(30) Foreign Application Priority Data
Sep. 2, 2014 (KR) 10-2014-0116468

(51) Int. Cl. H04L 29/06; G06F 17/30

(52) U.S. Cl. CPC H04L 63/1466; H04L 63/0236; H04L 63/1433; G06F 17/30864

(57) ABSTRACT

A system and method for detecting malicious code based on the Web are disclosed herein. The system includes a Uniform Resource Locator (URL) collection unit, a data crawling unit, a malicious code candidate extraction unit, and a secure pattern filtering unit. The URL collection unit collects and stores the URL information of a web server. The data crawling unit crawls and stores the contents data of a website. The malicious code candidate extraction unit detects a pattern, matching previously stored malicious pattern information, in the stored data, and extracts an event including the detected pattern as a malicious code candidate. The secure pattern filtering unit detects a pattern, matching previously stored secure pattern information known as being secure, in the extracted malicious code candidate, filters out the event including the detected pattern from the extracted malicious code candidate, and outputs a remaining malicious code candidate as malicious code.

### CROSS-REFERENCE TO RELATED APPLICATION

This application claims under 35 U.S.C. §119(a) the benefit of Korean Patent Application No. 10-2014-0116468 filed Sep. 2, 2014, which is incorporated herein by reference.

### TECHNICAL FIELD

The present invention relates generally to a system and method for detecting malicious code based on the Web, and more particularly to technology that can detect, in advance, and handle the spread of malicious code or abuse as a transit website via a webpage that is hacked using security vulnerability.

### BACKGROUND ART

The term “malicious code” refers to software that is intentionally constructed to perform a malicious activity, such as the destruction of a system, the leakage of information or the like, against the intention and interest of a user.

A representative malicious code spreading pathway is a pathway using various types of free software that can be easily obtained over the Internet. In many cases, these types of free software are file-sharing programs. When the corresponding programs are installed, malicious code is also installed.

Since these programs have been already exposed to the Internet for a long period of time, the programs can be detected by computer vaccine programs in many cases. In addition to this infection pathway, there are cases where malicious code is inserted into a website.

FIG. 1 is a diagram showing a malicious code infection pathway via a website in conventional technology. In FIG. 1, a user terminal 110, a website 120, a web server 130, and an attacker server 140 are shown.

When a user requests a visit to the website 120 using the user terminal 110, the web server 130 may provide the contents of the website 120 to the user terminal 110. In this case, when malicious code has been inserted into the website 120, visited by the user, by the intentional attack of a hacker, or when malicious code has been inserted into contents, constructed by a subcontractor, by a non-intentional attack, the malicious code hidden in a specific page is executed when the user simply visits the specific page of the website 120, and then the user terminal 110 accesses the attacker server 140 via a malicious code link 150. Accordingly, the user terminal 110 is made to download a malicious program 160 from the attacker server 140 and install the malicious program 160. In this case, the conventional technology cannot detect the installation and execution of the malicious code in advance.

Such an attack using security vulnerability is referred to as an exploit. The code of an exploit is frequently written in JavaScript, and is frequently made difficult to read usually through code obfuscation. In some cases, the code of an exploit has the attribute of being dynamically changed whenever a user visits a corresponding page.

This type of attack code obstructs the performance of patterning that is performed by a computer vaccine to detect malicious code. In particular, code that is dynamically and automatically changed cannot be detected by a vaccine in most cases.

Meanwhile, Korean Patent No. 1308228 entitled “Automatic Malicious Code Detection Method” presents technology that analyzes malicious code using both the types and sequence of events constituting a program and that classifies a program performing similar behavior in terms of functions as the same type, thereby improving the performance of a malicious code classification apparatus.

However, although this conventional technology has the advantage of detecting the same type of malicious code based on calculated similarity because the conventional technology calculates the similarity using the sequential characteristic of two pieces of malicious code including events selected from the same event pool, the conventional technology cannot detect the installation and execution of malicious code in advance. Accordingly, this conventional technology cannot protect against malicious code previously inserted into a website, i.e., an exploit attack using security vulnerability, and still has the risk of being infected with a malicious code attack.

### SUMMARY OF THE DISCLOSURE

Accordingly, the present invention has been made keeping in mind the above problems occurring in the prior art, and an object of the present invention is to provide a system and method for detecting malicious code based on the Web.

Another object of the present invention is to detect, in advance, and handle the spread of malicious code or abuse as a transit website via a webpage that is hacked using security vulnerability.

Still another object of the present invention is to reduce false negative detection (a phenomenon in which malicious code that must be detected is not detected) related to a new or variant type of malicious code.

Still another object of the present invention is to reduce false positive detection (a phenomenon in which normal code that must not be detected is falsely detected) during malicious code detection.

Yet another object of the present invention is to reduce the unnecessary consumption of resources and time when a webpage is inspected.

In accordance with an aspect of the present invention, there is provided a system for detecting malicious code based on the Web, the system detecting an attack of inserting malicious code into a web server, the system including a processor in which program instruction codes are loaded and executed. The processor includes: a Uniform Resource Locator (URL) collection unit configured to collect and store the URL information of at least one web server; a data crawling unit configured to crawl and store contents data present in a website based on the stored URL information; a malicious code candidate extraction unit configured to detect a pattern, matching previously stored malicious pattern information, in the data stored in the data crawling unit, and to extract an event including the detected pattern as a malicious code candidate; and a secure pattern filtering unit configured to detect a pattern, matching previously stored secure pattern information known as being secure, in the extracted malicious code candidate, to filter out the event including the detected pattern matching the secure pattern information from the extracted malicious code candidate, and to output a remaining malicious code candidate as malicious code.

The previously stored malicious pattern information may be generated using the remaining character string within a specific character string, previously known as malicious code, omitting and/or excluding part of the specific character string.

The system may further include a pattern learning unit, within the processor, configured to generate new malicious pattern information by analyzing the regularity of a malicious pattern or the correlation of a secure pattern with the malicious pattern based on the output malicious code, and to add the generated malicious pattern information to the previously stored malicious pattern information.

The data crawling unit may access the website using not only the source code of the website but also an IE component module, thereby storing a collected image, encoding JavaScript and style sheet data as the contents data.

The data crawling unit may store the data of the stored data, not matching the previously stored malicious pattern information, as a hash value; and the malicious code candidate extraction unit may detect a changed hash value by comparing the hash value, previously stored in the data crawling unit, with the hash value of additional contents data acquired by periodically crawling the contents data of the website, and may extract a malicious code candidate based on the detected changed hash value.

In accordance with another aspect of the present invention, there is provided a method of detecting malicious code based on the Web, the method detecting an attack of inserting malicious code into a web server, the method is executed by a processor when a program instruction codes are loaded into the processor, the method including: collecting and storing the Uniform Resource Locator (URL) information of at least one web server; crawling and storing contents data present in a website based on the stored URL information; detecting a pattern, matching previously stored malicious pattern information, in the stored contents data, and extracting an event including the detected pattern as a malicious code candidate; and detecting a pattern, matching previously stored secure pattern information known as being secure, in the extracted malicious code candidate, filtering out the event including the detected pattern from the extracted malicious code candidate, and outputting a remaining malicious code candidate as malicious code.

The previously stored malicious pattern information may be generated using the remaining character string within a specific character string, previously known as malicious code, omitting and/or excluding part of the specific character string.

The method may further include generating new malicious pattern information by analyzing the regularity of a malicious pattern or the correlation of a secure pattern with the malicious pattern based on the output malicious code, and adding the generated malicious pattern information to the previously stored malicious pattern information.

The crawling and storing contents data may include storing the data of the stored data, not matching the previously stored malicious pattern information, as a hash value; and the extracting an event including the detected pattern as a malicious code candidate may include detecting a changed hash value by comparing the previously stored hash value with the hash value of additional contents data acquired by periodically crawling the contents data of the website; and extracting a malicious code candidate based on the detected changed hash value.

In accordance with still another aspect of the present invention, there is provided a method of detecting malicious code based on the Web, in which malicious code or an exploit-related event is detected in a web document included in a primary URL website, and another website linked via a plurality of steps is tracked by tracking an event linked by code inside the former website, with the result that an event that induces the execution of malicious code can be detected. In this case, the web document of a linked website is also crawled and collected, and thus the security of the web document of the linked website may be checked. In this case, when the linked website is a website in the same domain, an event detection process may be temporarily omitted for an internal linker in another method of detecting malicious code based on the Web. The reason for this is to prevent the malicious code detection process from being redundantly performed, since a website inside a domain is ultimately crawled and collected and thus the detection of malicious code is performed in a separate process.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a diagram showing a malicious code infection pathway via a website in conventional technology;

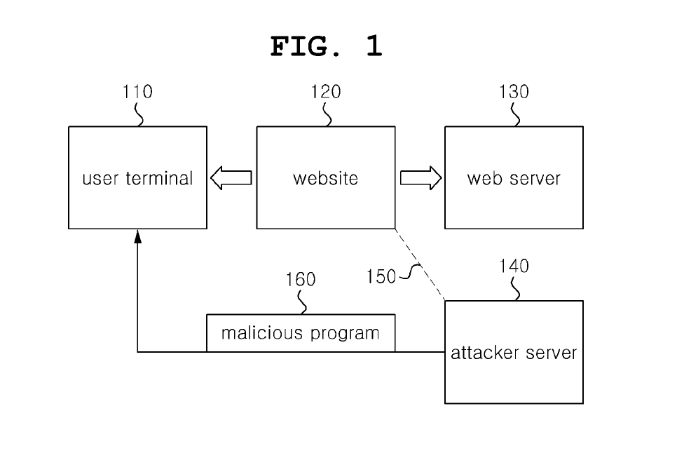

FIG. 2 is a diagram showing a system for detecting malicious code based on the Web according to an embodiment of the present invention;

FIG. 3 is a diagram showing a method of detecting malicious code based on the Web according to an embodiment of the present invention;

FIG. 4 is a diagram showing a method of detecting malicious code when periodically crawling contents data according to an embodiment of the present invention;

FIG. 5 is a diagram showing one step of the method of detecting malicious code based on the Web according to the embodiment of invention, which is shown in FIG. 3, in detail;

FIG. 6 is a diagram showing the process of tracking a site link event and detecting an inducement to malicious code in a method of detecting malicious code based on the Web according to an embodiment of the present invention;

FIG. 7 shows an example illustrating the process of a method of detecting malicious code based on the Web according to an embodiment of the present invention and the type of detected event; and

FIG. 8 shows an example illustrating the process of detecting hidden malicious code a primary URL and a detected html document in a method of detecting malicious code based on the Web according to an embodiment of the present invention.

### DETAILED DESCRIPTION OF THE DISCLOSURE

Hereinafter, embodiments of the present invention will be described in detail with reference to the accompanying drawings. In the following description of the present invention, detailed descriptions of related well-known components or functions that may unnecessarily make the gist of the present invention obscure will be omitted. Furthermore, in the descriptions of the embodiments of the present invention, specific numerical values correspond merely to embodiments.

The present invention relates generally to a system and method for detecting malicious code based on the Web, and more particularly to technology that can detect, in advance, and handle the spread of malicious code or abuse as a transit website via a webpage that is hacked using security vulnerability.

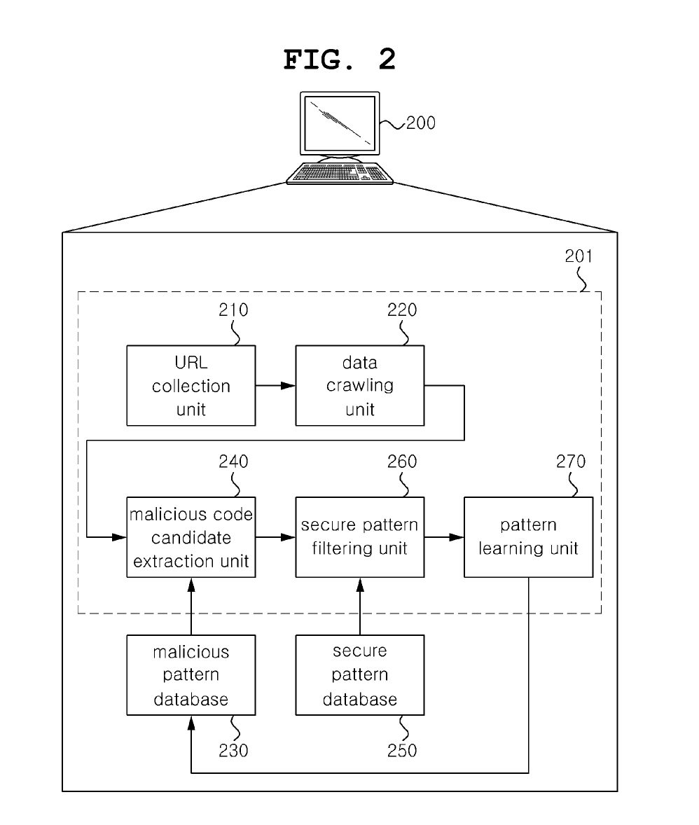

FIG. 2 is a diagram showing a system 200 for detecting malicious code based on the Web according to an embodiment of the present invention.

Referring to FIG. 2, the system 200 for detecting malicious code based on the Web according to the embodiment of the present invention includes a processor 201. The processor 201 includes a URL collection unit 210, a data crawling unit 220, a malicious code candidate extraction unit 240, a secure pattern filtering unit 260, and a pattern learning unit 270 as sub-module within the processor 201. The system 200 may further include a malicious pattern database 230, and a secure pattern database 250.

The URL collection unit 210 collects and stores the URL information of at least one web server. The system 200 for detecting malicious code based on the Web may access a website using link information, such as a URL.

The data crawling unit 220 crawls and stores contents data present in a website based on the URL information stored in the URL collection unit 210.

In this case, the system 200 for detecting malicious code based on the Web may access a webpage using an IE component module, which enables results, equivalent to those in the case of access using a web browser, to be collected. When the IE component module is used, not only code that is accessed when a general user accesses a webpage but also other contents data can be collected in an equivalent manner, and thus a user environment that may be exposed to malicious code may be reproduced close to an actual situation. That is, the system 200 for detecting malicious code based on the Web enables emulation by accessing the Web using the IE component module. In this case, the term “emulation” refers to a conservation strategy that emulates the operations of hardware, a medium, an operating system and software used when digital information was generated and reproduces them using a program that can read the contents of the emulated operations. Meanwhile, the term “IE component module” is merely an embodiment of a web data collection module intended adopted for the purpose of enabling the above emulation by the present invention. The IE component module that is intended by the present invention is a collection module that can reproduce a user environment, in which an actual user may be exposed to malicious code when collecting web data, close to an actual situation. Since the IE component module is a software module well known to the relevant technical field and is merely an embodiment selected to meet the intention of the present invention, the spirit of the present invention is not limited to this embodiment.

Accordingly, the system 200 for detecting malicious code based on the Web can overcome a problem in which in the case of the conventional technology, there is the risk of being infected with malicious code during the loading of contents because contents loaded during access using an IE web browser is not verified. Furthermore, the system 200 for detecting malicious code based on the Web can reduce the consumption of resources and extend the range of detection of malicious code because the system 200 for detecting malicious code based on the Web accesses the Web using the IE component module without actually executing an IE web browser.

The data crawling unit 220 accesses the Web using not only the source code (HTML) of a website but also the IE component module, thereby also crawling and storing additionally collected data, such as an image, encoding JavaScript, and a style sheet.

Furthermore, the data crawling unit 220 may store the data of the stored data that does not match the malicious pattern information previously stored in the malicious pattern database 230 (i.e., data that has not been extracted as a malicious code candidate) and data that has been filtered out based on a secure pattern as secure data by the secure pattern filtering unit 260 (i.e., data that is not malicious code), as a hash value.

Furthermore, the data crawling unit 220 periodically crawls the contents data of a website, and the malicious code candidate extraction unit 240 detects a changed hash value by comparing a hash value previously stored in the data crawling unit 220 with the hash value of additional contents data acquired by periodically crawling the website, and extracts a malicious code candidate based on the detected, changed hash value.

The malicious pattern database 230 stores malicious code pattern information generated using not only the information of a specific character string previously known as malicious code but also the remaining character string of the specific character string excluding part of the specific character string. That is, the malicious pattern database 230 databases and stores not only the information of previously known malicious code but also the information of the same type of malicious code whose pattern is similar to that of the previously known malicious code.

The malicious code candidate extraction unit 240 detects a pattern, matching malicious pattern information previously stored in the malicious pattern database 230, in data stored in the data crawling unit 220, and extracts an event including the detected pattern as a malicious code candidate.

In the case of the conventional technology, when malicious code is detected, detection is performed based on whether code in question is the same as previously known malicious code information. Accordingly, a correct detection rate increases, but many false negative detection cases where new malicious code or the same type of malicious code is not detected occur.

However, since the malicious pattern database 230 stores malicious code pattern information generated using not only the information of a specific character string previously known as malicious code but also the remaining character string of the specific character string excluding part of the specific character string, the malicious code candidate extraction unit 240 may detect malicious code using a wide range of patterns, unlike the conventional technology, when extracting a malicious code candidate, and may filter out a pattern, matching secure pattern information stored in the secure pattern database 250, from an extracted malicious code candidate, thereby reducing the false negative detection rate.

For example, when previously known malicious code is ABCDEF, the malicious code may evolve or be deformed into ABCCEF and perform the same function as malicious code. Accordingly, in an embodiment of the present invention, code having a form in which part of the previously known malicious code has been replaced with another pattern, such as ABC/C/EF, may be detected as the malicious code candidate. Further, another deformed malicious code also may be detected, in case that a part of the known malicious code omitted therein, such as ABCD/F.

In this case, the range of malicious code candidates may be excessively wide, and thus false positive detection (a case where code that is not malicious code is recognized as malicious code) may occur. In the present invention, a secure pattern previously known as being secure is detected, and thus false positive detection can be prevented.

Furthermore, new malicious pattern information acquired by the analysis of the pattern learning unit 270 may be added to the malicious pattern database 230.

Furthermore, the malicious code candidate extraction unit 240 may store the event information, extracted as the malicious code candidate, in a list structure. Furthermore, the malicious code candidate extraction unit 240 may store a history regarding a malicious pattern based on which the extracted event has been extracted as the malicious code candidate.

Accordingly, in order to filter out a secure pattern in the future, the malicious code candidate extraction unit 240 may database and store detailed information regarding the malicious pattern based on which the extracted event has been extracted and a location at which the corresponding character string of the extracted malicious pattern is placed.

The secure pattern database 250 stores a pattern previously known as being secure. This enables an event, falsely detected by the malicious code candidate extraction unit 240, to be filtered out using the secure pattern stored in the secure pattern database 250 when a malicious pattern and the secure pattern have similar character strings, thereby eliminating false positive detection.

Furthermore, the secure pattern stored in the secure pattern database 250 may be defined as an exceptional rule for a specific malicious pattern, and the secure pattern filtering unit 260 may filter out false positive detection from the extracted malicious code candidate using the secure pattern defined by the correlation of the malicious pattern with the secure pattern.

In other words, if a secure pattern is recognized as being secure unconditionally when the secure pattern is detected, there is a possibility of being recognized as being secure by a single secure pattern due to various malicious code-similar patterns (a possibility that code recognized as a malicious code candidate is not actually secure but is falsely recognized as being secure). In this case, a detection history regarding a malicious pattern that is similar to the malicious code candidate and that has contributed to the recognition as the malicious code candidate is also stored, thereby also preventing a phenomenon in which the false negative detection rate is excessively increased by the secure pattern. When a malicious code candidate is selected because the malicious code candidate is similar to a plurality of malicious patterns, an exception handling rule in which code in question is excluded from the malicious code candidate only if the security of the code against all the malicious patterns has been proved may be provided additionally.

The secure pattern filtering unit 260 detects a pattern, matching secure pattern information previously stored in the secure pattern database unit 250 and known as being secure, in the malicious code candidate extracted by the malicious code candidate extraction unit 240, filters out an event including the detected pattern from the extracted malicious code candidate, and outputs the remaining malicious code candidate as malicious code.

In this case, the secure data filtered out by the secure pattern filtering unit 280 may be stored in the data crawling unit 220 as a hash value, whereas a user may be alerted to the remaining malicious code candidate data as malicious code.

The secure pattern filtering unit 260 leaves only an event having a strong correct detection possibility by filtering out an event including the secure pattern from the malicious code candidate, thereby reducing the omission of detection of new malicious code or the same type of malicious code.

The pattern learning unit 270 generates new malicious pattern information by analyzing the regularity of the malicious pattern or the correlation of the secure pattern with the malicious pattern based on the malicious code output by the secure pattern filtering unit 260, and adds the generated malicious pattern information to the malicious pattern database 230.

Accordingly, the pattern learning unit 270 may gradually increase the correct detection rate of the remaining event as the secure pattern filtering unit 260 continues filtering, and may acquire a larger amount of new malicious pattern information.

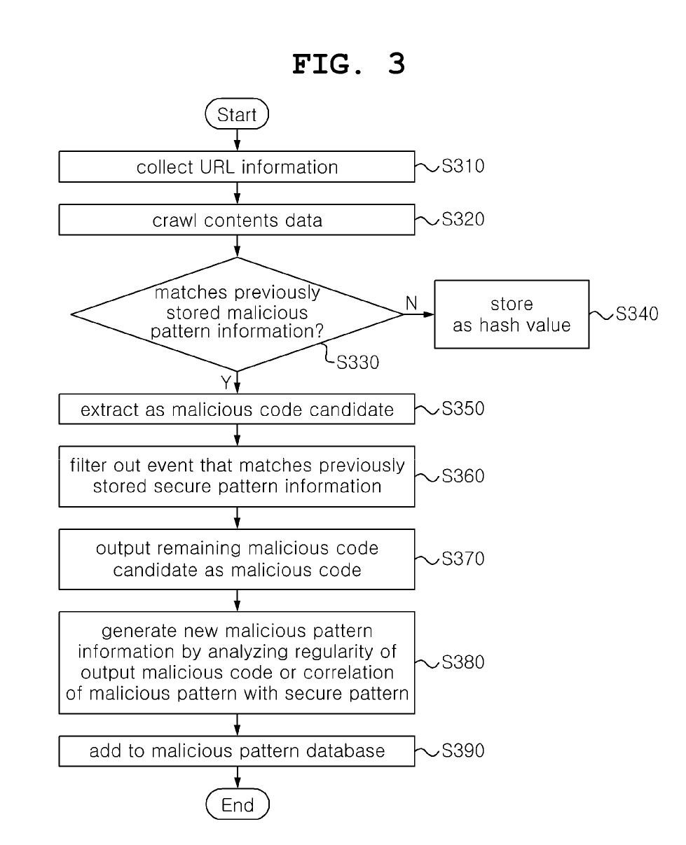

FIG. 3 is a diagram showing a method of detecting malicious code based on the Web according to an embodiment of the present invention.

Referring to FIG. 3, the URL collection unit 210 collects and stores the URL information of at least one Web server at step S310. This enables the system 200 for detecting malicious code based on the Web to access a website using link information, such as a URL.

Furthermore, the data crawling unit 220 crawls and stores contents data present in the website based on the URL information stored in the URL collection unit 210 at step S320. In this case, the crawled and stored data may be data, such as an image, encoding JavaScript and a style sheet, that is additionally collected by accessing the Web using not only the source code (HTML) of the website but also an IE component module.

In this case, the system 200 for detecting malicious code based on the Web according to the present invention may access a webpage using an IE component module, which enables results, equivalent to those in the case of access using a web browser, to be collected. That is, the system 200 for detecting malicious code based on the Web enables emulation by accessing the Web using an IE component module.

Accordingly, the system 200 for detecting malicious code based on the Web can achieve the effect of overcoming a problem in which in the case of the conventional technology, there is the risk of being infected with malicious code during the loading of contents because contents loaded during access using an IE web browser is not verified. Furthermore, the system 200 for detecting malicious code based on the Web can achieve the effects of reducing the consumption of resources and extending the range of detection of malicious code because the system 200 for detecting malicious code based on the Web accesses the Web using an IE component module without actually executing an IE web browser.

Thereafter, the malicious code candidate extraction unit 240 checks whether there is a pattern, matching the malicious pattern information previously stored in the malicious pattern database 230, in the data stored in the data crawling unit 220 at step S330.

In this case, the malicious pattern information previously stored in the malicious pattern database 230 may be malicious code pattern information generated using not only the information of a specific character string previously known as malicious code but also the remaining character string of the specific character string excluding part of the specific character string. That is, the malicious pattern database 230 may database and store not only the information of previously known malicious code but also the information of the same type of malicious code whose pattern is similar to that of the previously known malicious code.

Thereafter, the malicious code candidate extraction unit 240 extracts an event including the detected pattern as a malicious code candidate at step S350 when the malicious code candidate extraction unit 240 has detected a pattern, matching malicious pattern information previously stored in the malicious pattern database 230, in data stored in the data crawling unit 220 in the case of Y at step S330, and stores the data (that is, data that has not been extracted as a malicious code candidate in the case of N at step S330) of the data stored in the data crawling unit 220, not matching the previously stored malicious pattern information, as a hash value at step S340.

In this case, at step S350, since the malicious pattern database 230 stores malicious code pattern information generated using not only the information of a specific character string previously known as malicious code but also the remaining character string of the specific character string excluding part of the specific character string, malicious code may be detected using a wide range of patterns, unlike in the conventional technology, thereby achieving the effect of reducing the false negative detection rate. Furthermore, that malicious code candidate extraction unit 240 that extracts malicious code candidate at step S350 may store the event information extracted as the malicious code candidate in a list structure. Furthermore, the malicious code candidate extraction unit 240 may store a history regarding a malicious pattern based on which the extracted event has been extracted as the malicious code candidate. That is, in order to filter out a secure pattern in the future, the malicious code candidate extraction unit 240 may database and store detailed information regarding the malicious pattern based on which the extracted event has been extracted and a location at which the corresponding character string of the extracted malicious pattern is placed.

Thereafter, after the malicious code candidate has been extracted at step S350, the secure pattern filtering unit 260 detects a pattern, matching secure pattern information previously stored in the secure pattern database unit 250 and known as being secure, in the malicious code candidate extracted by the malicious code candidate extraction unit 240, filters out an event including the detected pattern from the extracted malicious code candidate at step S360, and outputs the remaining malicious code candidate as malicious code at step S370.

In this case, the secure pattern database 250 stores a pattern previously known as being secure. This enables an event, falsely detected by the malicious code candidate extraction unit 240, to be filtered out using the secure pattern stored in the secure pattern database 250 when a malicious pattern and the secure pattern have similar character strings, thereby eliminating false positive detection.

Furthermore, the secure pattern stored in the secure pattern database 250 may be defined as an exceptional rule for a specific malicious pattern, and the secure pattern filtering unit 260 may filter out false positive detection from the extracted malicious code candidate using the secure pattern defined by the correlation of the malicious pattern with the secure pattern.

In this case, the secure data filtered out by the secure pattern filtering unit 280 is stored in the data crawling unit 220 as a hash value, whereas a user may be alerted to the remaining malicious code candidate data as malicious code.

Furthermore, the secure pattern filtering unit 260 leaves only an event having a strong correct detection possibility by filtering out an event including the secure pattern from the malicious code candidate, thereby reducing the omission of detection of new malicious code or the same type of malicious code.

Thereafter, after the malicious code has been output at step S370, the pattern learning unit 270 generates new malicious pattern information by analyzing the regularity of the malicious pattern or the correlation of the secure pattern with the malicious pattern based on the malicious code output by the secure pattern filtering unit 260 at step S380, and adds the generated malicious pattern information to the malicious pattern database 230 at step S390.

Accordingly, the correct detection rate of the remaining event may be gradually increased as the secure pattern filtering unit 260 continues to filter out a secure pattern, and a larger amount of new malicious pattern information may be acquired.

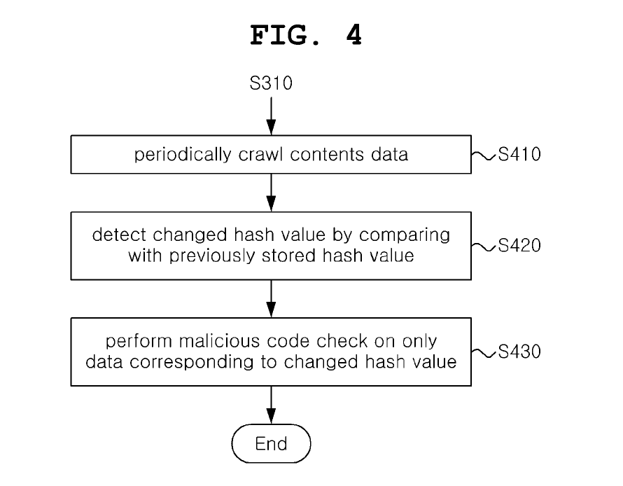

FIG. 4 is a diagram showing a method of detecting malicious code when periodically crawling contents data according to an embodiment of the present invention.

Referring to FIG. 4, the data crawling unit 220 periodically crawls and stores contents data present in a website based on the URL information, collected in the URL collection unit 210 at step S310, at step S410.

Furthermore, the malicious code candidate extraction unit 240 detects a changed hash value by comparing a hash value previously stored in the data crawling unit 220 with the hash value of additional contents data acquired by periodically crawling the website at step S420, and performs malicious code check on only data corresponding to the detected changed hash value at step S430.

In this case, the periodically crawled and stored data may be data, such as an image, encoding JavaScript and a style sheet, that is additionally collected by accessing the Web using not only the source code (HTML) of the website but also an IE component module.

Furthermore, at step S430, malicious code check is performed on only data corresponding to the changed hash value, thereby effectively reducing a problem in which in the conventional technology, the unnecessary consumption of resources and time occurs because check is performed even when there is no change during the inspection of a webpage.

Furthermore, since step S430 of checking malicious code may be performed via steps identical to steps S330 to S390 of FIG. 3 and these steps have been described in detail above, a description of step S430 is omitted.

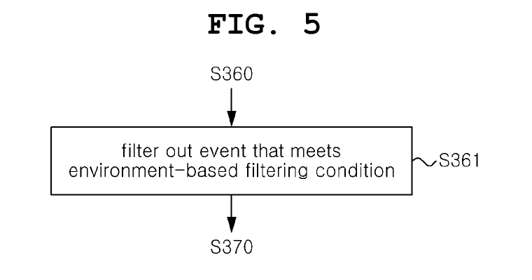

FIG. 5 is a diagram showing one step of the method of detecting malicious code based on the Web according to the embodiment of invention, which is shown in FIG. 3, in detail.

Referring to FIG. 5, after step S360 of filtering out a secure pattern has been performed, the method of detecting malicious code based on the Web may filter out an event that meets an environment-based filtering condition at step S361. In this case, the environment-based filtering condition is a filtering condition adapted to prevent a redundant process that is set up by a malicious code detection environment. That is, since malicious code detection is performed using a separate process, an environment-based filtering condition is set up in order to prevent redundant detection and reduce unnecessary computational load and memory usage, and an event that will result in a redundant process is filtered out in advance. As an example, in the case where all documents inside a domain are crawled and a malicious code detection process related to a malicious code character string and code execution is separately performed, it is not necessary to redundantly detect a malicious code link event induced by a link inside the domain. In this case, the environment-based filtering condition may be an “intra-domain link event,” and the intra-domain link event may be filtered out and be temporarily excluded during malicious code detection.

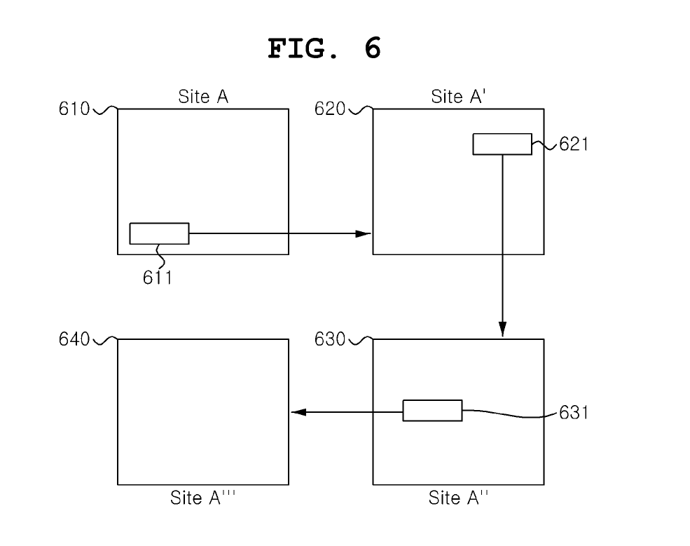

FIG. 6 is a diagram showing the process of tracking a site link event and detecting an inducement to malicious code in a method of detecting malicious code based on the Web according to an embodiment of the present invention.

Referring to FIG. 6, the method of detecting malicious code based on the Web according to the embodiment of the present invention may analyze the security of a web document through the crawling of a website A′ 620 linked by the specific code 611 of a website A 610. In this case, code 631 linked to a website A″′ 640 may be detected through crawling or document code analysis related to a website A″ 630 linked by specific code 621 inside a website A′ 620.

As described above, the method of detecting malicious code based on the Web according to the present invention may verify not only a document inside the website A 610 but also the security of other websites 620 to 640 linked by the document. When a user intentionally or unintentionally clicks the link of the code 611 using a mouse in the state in which the website A 610 is displayed, the website A′ 620 will be executed by a link event, and thus the security of the website may be verified also taking into account such an accidental event. It will be apparent that not only a link generated by the accidental click of a user but also a link event automatically executed by a hidden process may be verified using a method, such as that of FIG. 6.

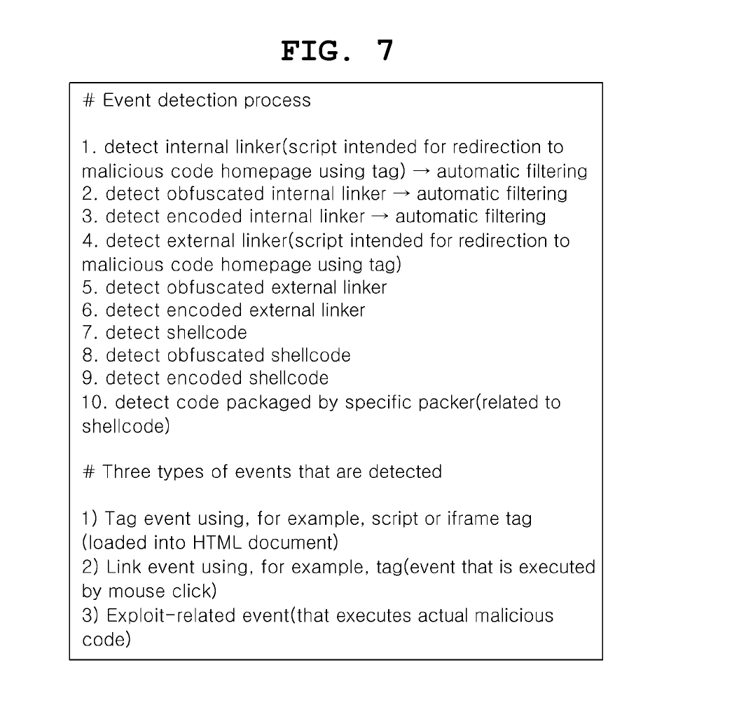

FIG. 7 shows an example illustrating the process of a method of detecting malicious code based on the Web according to an embodiment of the present invention and the type of detected event.

Referring to FIG. 7, the method of detecting malicious code based on the Web according to the embodiment of the present invention may have the basic function of detecting a script (an external linker) intended for inducement to re-direction to a malicious code homepage using a web document external tag and alerting a user to the script as malicious code. In this case, even when a linker outside a web document is obfuscated or encoded, the linker is detected by decryption or decoding and is then filtered out. Since well-known method are used as encoding and decoding methods used in this case, the encoding and decoding methods do not fall within the important range of the present invention, and a detailed description thereof is omitted.

Furthermore, in the method of detecting malicious code based on the Web according to the embodiment of the present invention, the handling of a script (an internal linker) that is present inside a web document and induces re-direction to a malicious code homepage using a tag may be allotted to the malicious code detection algorithm of a subsequent step, and the burden of malicious code detection logic may be reduced by performing automatic filtering at a current step. In this case, in the process of detecting an internal linker, the handling of an obfuscated or encoded linker is the same as the handling of the internal linker.

Furthermore, the method of detecting malicious code based on the Web according to the embodiment of the present invention may detect malicious code by detecting a shellcode. In this case, an obfuscated or encoded shellcode may be detected. Furthermore, in this case, the method of detecting malicious code based on the Web according to the embodiment of the present invention may detect a shellcode intended for inducement to hidden malicious code by detecting code packaged by a specific packer.

In this case, three types of events that are detected may include a tag event using a script, an iframe tag or the like, a link event using a tag, and an exploit-related event that executes actual malicious code.

A method of reducing the computational load and memory usage of the process of detecting malicious code in a method of detecting malicious code based on the Web according to an embodiment of the present invention is as follows. In a method of detecting malicious code based on the Web according to an embodiment of the present invention, in the case of the tag event, code loaded in the same domain is primarily assumed to be trustworthy, is automatically filtered out, and is not detected as malicious code. In the case of the link of an internal document, a linked document is crawled in a separate process and malicious code is detected, thereby preventing computational load and memory usage from being unnecessarily increased by a redundant process.

In a method of detecting malicious code based on the Web according to an embodiment of the present invention, a tag event that is loaded in another domain is not trustworthy and a user is alerted to the event. This is an essential procedure because there is no separate verification method for another domain.

In a method of detecting malicious code based on the Web according to an embodiment of the present invention, a URL inside a link event is accessed, and a response value is detected. When a tag event is the same as the URL of the link event in the corresponding response value, the tag event may be filtered out because it will be verified in a subsequent-depth detection process.

In a method of detecting malicious code based on the Web according to an embodiment of the present invention, an exploit-related event may be considered not to be trustworthy in all domains, and a user may be alerted to the exploit-related event unconditionally.

The event detection logic of FIG. 7 may be executed within a single depth.

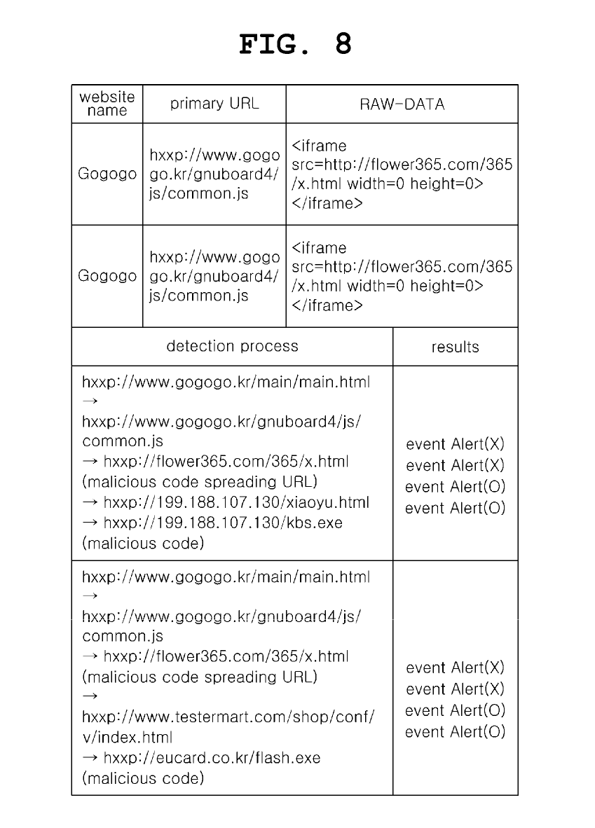

FIG. 8 shows an example illustrating the process of detecting hidden malicious code a primary URL and a detected html document in a method of detecting malicious code based on the Web according to an embodiment of the present invention.

Referring to FIG. 8, the URL of a specific website and the raw data of the web document of the specific website are primarily crawled, and whether the website corresponds to malicious code is detected. In this case, whether a linked website/document executes malicious code may be detected by tracking a link event based on a tag or the like. In this case, although FIG. 8 illustrates the 3-step process of tracking an external link, the spirit of the present invention is not limited to this embodiment.

In the method of detecting malicious code based on the Web according to the embodiment of the present invention, code inside a website/document intended for the inducement to executed malicious code may be recognized as malicious code spreading or inducement code, and a database for the recognition of malicious code may be additionally updated.

In this case, a tag event linked inside a domain will be checked by crawling the raw data of the internal document of the corresponding domain in a separate independently executed process, and thus may not be recognized as malicious code and automatically filtered out in an event detection process. However, this malicious code will be ultimately found in the separate process of verifying an internal document and will then be excluded.

Furthermore, although not shown in the drawings, a method of detecting malicious code based on the Web according to an embodiment of the present invention provides a user interface for enabling individual request URLs and response data corresponding thereto to be selectively looked up. These data may be classified into categories, such as raw data, a URL list, etc., and may then be provided.

In a method of detecting malicious code based on the Web according to an embodiment of the present invention, malicious code or an exploit-related event is detected in a web document included in a primary URL website, and another website linked via a plurality of steps is tracked by tracking an event linked by code inside the former website, with the result that an event that induces the execution of malicious code can be detected. In this case, the web document of a linked website is also crawled and collected, and thus the security of the web document of the linked website may be checked. In this case, when the linked website is a website in the same domain, an event detection process may be temporarily omitted for an internal linker in a method of detecting malicious code based on the Web according to another embodiment of the present invention. The reason for this is to prevent the malicious code detection process from being redundantly performed, since a website inside a domain is ultimately crawled and collected and thus the detection of malicious code is performed in a separate process.

A method of detecting malicious code based on the Web according to at least one embodiment of the present invention may be implemented in the form of program instructions that can be executed by a variety of computer means, and may be stored in a computer-readable storage medium. The computer-readable storage medium may include program instructions, a data file, and a data structure solely or in combination. The program instructions that are stored in the medium may be designed and constructed particularly for the present invention, or may be known and available to those skilled in the field of computer software. Examples of the computer-readable storage medium include magnetic media such as a hard disk, a floppy disk and a magnetic tape, optical media such as CD-ROM and a DVD, magneto-optical media such as a floptical disk, and hardware devices particularly configured to store and execute program instructions such as ROM, RAM, and flash memory. Examples of the program instructions include not only machine language code that is constructed by a compiler but also high-level language code that can be executed by a computer using an interpreter or the like. The above-described hardware components may be configured to act as one or more software modules that perform the operation of the present invention, and vice versa.

The present invention has the advantage of detecting, in advance, and handling the spread of malicious code or abuse as a transit website via a webpage that is hacked using security vulnerability.

The present invention has the advantage of reducing the false negative detection of a new or variant type of malicious code because to detect malicious code, detection is performed using a wide range of patterns and then a secure pattern known as being secure is filtered out.

The present invention has the advantage of reducing the consumption of resources and expanding the range of malicious code detection because a website is emulated using an IE component module and thus results equivalent to those in the case of access to the Web using a web browser can be collected without actually executing an IE web browser.

The present invention has the advantage of enabling IE-level analysis via not only simple analysis related to HTML but also the analysis of various types of contents, such as an image, encoding JavaScript, a style sheet, etc.

The present invention has the advantage of reducing the unnecessary consumption of resources and time because a changed hash value is detected by comparing a hash value previously stored in the data crawling unit with the hash value of additional contents data acquired by periodically crawling the contents data of the website and then malicious code check is performed on only data corresponding to the detected changed hash value.

Furthermore, the present invention is advantageous in that to ensure the security of a website, an analysis target range can be expanded to an additional website linked to a crawled web document and the security of the website can be further increased by repeating the above process a plurality of times. In this case, a link inside the website is a link to a document/website inside a domain in many cases, and thus it is not necessary to use large amounts of computational load and memory in order to detect an event that can be detected by a malicious code analysis process for a web document. Accordingly, when a link event is a link to an internal document, computational load and memory usage can be reduced by temporarily releasing a malicious code detection process. That is, in the process of expanding the range of malicious code detection, only a single detection process is performed for redundant detection processes, and thus redundant computational load and memory usage can be reduced.

While the present invention has been described in conjunction with specific details, such as specific configuration elements, and limited embodiments and diagrams above, these are provided merely to help an overall understanding of the present invention, the present invention is not limited to these embodiments, and various modifications and variations can be made based on the above description by those having ordinary knowledge in the art to which the present invention pertains.

Accordingly, the technical spirit of the present invention should not be determined based on only the described embodiments, and the following claims, all equivalents to the claims and equivalent modifications should be construed as falling within the scope of the spirit of the present invention.

What is claimed is :

1. A system for detecting malicious code based on the Web, the system detecting an attack of inserting malicious code into a web server, the system comprising a processor configured to:
collect and store URL information of at least one web server;
crawl and store contents data present in a website based on the stored URL information;
detect a pattern, matching previously stored malicious pattern information, in the data stored in the data crawling unit;
extract an event including the detected pattern as a malicious code candidate;
detect a pattern, matching previously stored secure pattern information known as being secure, in the extracted malicious code candidate;
filter out the event including the detected pattern matching the secure pattern information from the extracted malicious code candidate; and
output a remaining malicious code candidate as malicious code.

2. The system of claim 1, wherein the previously stored malicious pattern information is generated using a remaining character string within a specific character string, previously known as malicious code, when part of the specific character string is excluded.

3. The system of claim 1, the processor is further configured to:
generate new malicious pattern information by analyzing regularity of a malicious pattern or correlation of a secure pattern with the malicious pattern based on the output malicious code; and
add the generated malicious pattern information to the previously stored malicious pattern information.

4. The system of claim 1, the processor is further configured to access the website using not only source code of the website but also an IE component module, thereby storing a collected image, encoding JavaScript and style sheet data as the contents data.

5. The system of claim 1, the processor is further configured to:
store data of the stored data, not matching the previously stored malicious pattern information, as a hash value;
detect a changed hash value by comparing the hash value, previously stored in the data crawling unit, with a hash value of additional contents data acquired by periodically crawling contents data of the website; and
extract a malicious code candidate based on the detected changed hash value.

6. A method of detecting malicious code based on the Web, the method detecting an attack of inserting malicious code into a web server, the method comprising:
collecting and storing, by a processor, Uniform Resource Locator (URL) information of at least one web server;
crawling and storing, by the processor, contents data present in a website based on the stored URL information;
detecting, by the processor, a pattern matching previously stored malicious pattern information, in the stored contents data;
extracting, by the processor, an event including the detected pattern as a malicious code candidate;
detecting, by the processor, a pattern matching previously stored secure pattern information known as being secure, in the extracted malicious code candidate;
filtering out, by the processor, the event including the detected pattern from the extracted malicious code candidate; and
outputting, by the processor, a remaining malicious code candidate as malicious code.

7. The method of claim 6, wherein the previously stored malicious pattern information is generated using a remaining character string within a specific character string, previously known as malicious code, when part of the specific character string is excluded.

8. The method of claim 6, further comprising:
generating, by the processor, new malicious pattern information by analyzing regularity of a malicious pattern or correlation of a secure pattern with the malicious pattern based on the output malicious code; and
adding, by the processor, the generated malicious pattern information to the previously stored malicious pattern information.

9. The method of claim 6, wherein:
the crawling and storing contents data comprises storing data of the stored data, not matching the previously stored malicious pattern information, as a hash value; and
the extracting an event including the detected pattern as a malicious code candidate comprises:
detecting, by the processor, a changed hash value by comparing the previously stored hash value with a hash value of additional contents data acquired by periodically crawling contents data of the website; and
extracting, by the processor, a malicious code candidate based on the detected changed hash value.

10. A non-transitory computer-readable medium containing program instructions that, when executed by a processor, causes the processor to execute a method of detecting malicious code based on the Web, the method detecting an attack of inserting malicious code into a web server, comprising:
program instructions that collect and store URL information of at least one web server;
program instructions that crawl and store contents data present in a website based on the stored URL information;
program instructions that detect a pattern, matching previously stored malicious pattern information, in the data stored in the data crawling unit;
program instructions that extract an event including the detected pattern as a malicious code candidate;
program instructions that detect a pattern, matching previously stored secure pattern information known as being secure, in the extracted malicious code candidate;
program instructions that filter out the event including the detected pattern matching the secure pattern information from the extracted malicious code candidate; and
program instructions that output a remaining malicious code candidate as malicious code.
